(19) United States
(12) Patent Application Publication
(10) Pub. No.: US 2023/0253841 A1
(43) Pub. Date: Aug. 10, 2023

(54) ROTOR ASSEMBLY

(71) Applicant: JAGUAR LAND ROVER LIMITED, Whitley, Coventry, Warwickshire (AU)

(72) Inventors: Istvan KIRALY, Coventry, West Midlands (GB); Tiago CESA, Coventry, West Midlands (GB)

(21) Appl. No.: 18/012,619

(22) PCT Filed: Jun. 25, 2021
(86) PCT No.: PCT/EP2021/067577

§ 371 Date: Dec. 22, 2022

(30) Foreign Application Priority Data
Jun. 26, 2020 (GB) 2009801.8

(51) Int. Cl. H02K 1/276

(52) U.S. Cl. CPC H02K 1/2766

(57) ABSTRACT

Aspects of the present invention relate to a rotor assembly (3) for an electric machine (1). The rotor assembly (3) includes a rotor (6). A plurality of permanent magnets (10) are mounted in respective magnet mounting apertures (11) formed in the rotor (6). The permanent magnets (10) each have first and second ends (15A, 15B). The rotor (6) has a plurality of circumferential rotor sections (20-n) formed between one or more of the magnet mounting apertures (11) and an outer circumference (C1) of the rotor (6). The circumferential rotor sections (20-n) each have at least one demagnetization protection barrier (21) for controlling a magnetic field applied to an associated one of the permanent magnets (10) during a demagnetization event. The present invention also relates to a rotor (6); and an electric machine (1) having a rotor assembly (3). The electric machine (1) is suitable for use in an electric drive unit for a vehicle (1).

### TECHNICAL FIELD

The present disclosure relates to a rotor assembly. Aspects of the invention relate to a rotor assembly, a rotor having a demagnetization protection barrier, an electric machine and a vehicle, such as an automobile. One or more demagnetization protection barrier may be provided in the rotor.

### BACKGROUND

Electrical vehicles have an electrical drive unit (EDU) comprising one or more electric machine in the form of a drive motor. In the event of an operational failure, a transient regime may occur which can damage the electromagnetic system of the electrical motor. The most frequently used regime to reduce or minimise damage is a three-phase short circuit. The three-phase short circuit is immediately applied to isolate the electric machine from the rest of electrical system. The electric machine may be isolated, thereby reduce or preventing propagation of the electrical failure from other components in the electrical system. The three-phase short circuit may in turn protect the electric machine from those electrical failures.

The instantaneous short circuit of a synchronous electric motor comprising permanent magnets causes the electromagnetic system to produce a transient regime in the electric machine. This transient regime can cause high electromagnetic stresses on the permanent magnets which can damage the magnetic properties of the permanent magnets and may lead to performance reduction of the electric machine. These electromagnetic stresses are particularly significant at higher temperature values, where the resilience of the permanent magnets may be lower. The associated risks may be managed by performance reduction at higher magnet temperatures.

It has been recognised that the permanent magnets disposed closest to the air gap between the rotor and the stator are at particular risk of demagnetization due to the electromagnetic stresses. For example, the permanent magnets may be arranged in parallel layers in the rotor. In this configuration, the permanent magnets closest to the air gap are affected most by the electromagnetic stresses. These electromagnetic stresses are resulted by magnetic flux which attempt to close through the path with lowest reluctance during the transient short circuit regime. These paths frequently traverse the corners of the permanent magnet(s) closest to the air gap. Accordingly, these corners of the permanent magnet(s) are most affected by demagnetization. The high level of demagnetization can result in permanent loss of magnetization of the permanent magnets. This may reduce the capability of the electric machine.

It is an aim of the present invention to address one or more of the disadvantages associated with the prior art.

### SUMMARY OF THE INVENTION

Aspects and embodiments of the invention provide a rotor assembly for an electric machine, a rotor, an electric machine and an electric vehicle as claimed in the appended claims.

According to an aspect of the present invention there is provided a rotor assembly for an electric machine, the rotor assembly comprising:
a rotor;
a plurality of permanent magnets mounted in respective magnet mounting apertures formed in the rotor, each permanent magnet having first and second ends;
a plurality of circumferential rotor sections, each circumferential rotor section being formed between one or more of the magnet mounting apertures and an outer circumference of the rotor;
wherein each circumferential rotor section comprises at least one demagnetization protection barrier for controlling a magnetic field applied to an associated one of the permanent magnets during a demagnetization event.

The at least one demagnetisation protection barrier in each circumferential rotor section may control or modify the flux density distribution locally. For example, the demagnetisation protection barrier(s) may modify the flux distribution in one or more magnet disposed in a radially outer position in the rotor. At least in certain embodiments, the one or more magnet disposed closest to the air gap is most affected by demagnetisation. This may result from the relatively small area in the rotor through which the magnetic flux travels. The demagnetisation protection barrier(s) may have reduced influence on the flux distribution through one or more magnet disposed in a radially inner position. The one or more magnet disposed in a radially inner position (away from the air gap) may be less affected as there is more space between the magnets and the rotor surface for distribution of the magnetic flux.

The demagnetization event may, for example, comprise a transient short circuit. The transient short circuit may be performed to isolate the electric machine, for example in the event of a system failure. The demagnetization event may result in application of a magnetic flux which may permanently damage one or more of the permanent magnets. A portion of the permanent magnet(s) may be at least partially demagnetized. At least in certain embodiments, the at least one demagnetization protection barrier may reduce the magnetic flux in one or more of the permanent magnets. The magnitude of the magnetic flux is typically greatest at or proximal to the corners of the permanent magnet, particularly one or more corner disposed on a radially outer side of the permanent magnet closest to an outer circumference of the rotor. The at least one demagnetization protection barrier may be configured to reduce the amount of magnetic flux applied to any such corner of the associated permanent magnet. The rotor may have improved failure resistance and, at least in certain embodiments, this may increase the reliability of the electric drive unit and related system components.

The electric machine may, for example, be used in an electric drive unit of a vehicle. Other applications of the electric machine are also contemplated.

At least in certain embodiments, the at least one demagnetization protection barrier may enable an increase in an operating temperature of the permanent magnet(s). This may allow the electric machine to operate at higher temperatures. The higher operating temperatures may increase the capability of electric motor.

The rotor may be composed of a material having a high magnetic permeability. The rotor may, for example, be formed from a plurality of laminations. The at least one demagnetization protection barrier may have a lower permeability than the material used to form the rotor. The at least one demagnetization protection barrier may comprise one or more aperture formed in the rotor. The aperture(s) may be hollow or may be filled, for example comprising a material having a permeability which is lower than that of the material forming the rotor. The at least one demagnetization protection barrier may reduce a magnitude of the magnetic flux applied to the associated permanent magnet during a demagnetization event.

It has been determined that a direction of the magnetic flux during a demagnetization event may be approximately perpendicular to a direction of the magnetic flux during normal operation. The or each demagnetization protection barrier may be configured to have a higher reluctance in a first direction than in a second direction. The first direction and the second direction may be substantially perpendicular to each other. The first direction may be at least substantially aligned with the magnetic flux in the rotor during demagnetization event. The second direction may be at least substantially aligned with the magnetic flux in the rotor during normal operation. Thus, the at least one demagnetization protection barrier may cause a larger increase in the reluctance during a demagnetization event than during normal operation.

At least in certain embodiments, the at least one demagnetization protection barrier may be configured to direct the magnetic flux to close through a magnetic path spaced apart from the corners of the permanent magnet. This may reduce or prevent permanent damage of the associated permanent magnet.

The at least one demagnetization protection barrier may be suitable for controlling the magnetic field to reduce or control a magnetic flux in the first end and/or the second end of the associated permanent magnet during the demagnetization event. This may reduce a peak magnitude of the magnetic flux in the associated permanent magnet. The at least one protection barrier may help to distribute the flux density more evenly through the permanent magnet. The at least one demagnetization protection barrier is effective in re-distributing the magnetic flux through the associated permanent magnet. By directing the flux density away from the corner(s) of the permanent magnet, the localized demagnetization of the permanent magnet may be reduced. In the event of a demagnetization event, the at least one demagnetization protection barrier may reduce the flux density to reduce or prevent demagnetization.

The at least one demagnetization protection barrier may be suitable for controlling a direction of the magnetic field in the circumferential rotor section during the demagnetization event to reduce the magnetic flux at a first corner disposed at the first end of the associated permanent magnet and/or to reduce the magnetic flux at a second corner disposed at the second end of the associated permanent magnet.

The at least one demagnetization protection barrier may be suitable for directing a portion (or a larger proportion) of the magnetic field in the circumferential rotor section inwardly through the associated permanent magnet. The magnetic flux may be directed through the associated permanent magnet inboard of the first end or the second end. The magnetic field may be directed through a medial region of the associated permanent magnet inboard.

The at least one demagnetization protection barrier may be configured to direct the magnetic field into the associated permanent magnet. The at least one demagnetization protection barrier may be configured to direct the magnetic field into an outer face of the permanent magnet. The magnetic field may be directed into the outer face of the permanent magnet away from a corner of the permanent magnet, thereby reducing the magnetic flux at the corner.

The demagnetization protection barrier may thereby reduce the magnetic flux in the associated permanent magnet during the short circuit event. In particular, the demagnetization protection barrier may reduce the magnetic flux occurring at one or more corner of the associated permanent magnet during the short circuit event.

The or each demagnetization protection barrier in each circumferential rotor section may be at least substantially aligned with the first end or the second end of the associated permanent magnet. The or each demagnetization protection barrier in each circumferential rotor section may be disposed in a position inset from the first end or the second end of the associated permanent magnet. The or each demagnetization protection barrier may be positioned towards a mid-point of the associated permanent magnet. The or each demagnetization protection barrier may be inset in a circumferential direction.

The permanent magnets may extend in a tangential direction. For example, the permanent magnets may be oriented substantially perpendicular to a radius of the rotor.

A radial extent of the or each demagnetization protection barrier may increase in a circumferential direction towards a centre of the permanent magnet.

The magnet mounting apertures may each comprise first and second extension portions associated with respective first and second ends of the permanent magnet. The or each demagnetization protection barrier in each circumferential rotor section may be disposed inboard of the first and second extension portions. The term inboard and outboard are used herein in relation to a direct axis of the associated rotor pole.

The or each circumferential rotor section may comprise first and second recesses formed in the outer circumference of the rotor. The or each demagnetization protection barrier in each circumferential rotor section may be disposed in a position outboard of one of the first and second recesses.

The or each demagnetization protection barrier may be elongated along a longitudinal axis at least substantially aligned with a local direction of the magnetic field during the demagnetization event. Each demagnetization protection barrier may have a first dimension (length) along the longitudinal axis which is greater than a second dimension (width) along a transverse axis.

The or each demagnetization protection barrier may be elongated along a longitudinal axis at least substantially perpendicular to a local direction of the magnetic field during normal operation of the electric machine.

The or each demagnetization protection barrier may be elongated along a longitudinal axis at least substantially perpendicular to a radius of the rotor extending through a centre of the associated permanent magnet.

The or each demagnetization protection barrier in each circumferential rotor section may be positioned at least substantially midway between (a radially outer edge of) the magnet mounting aperture and the outer circumference of the rotor. Of course, the or each demagnetization protection barrier may be offset from this central position.

Within each circumferential rotor section, a first one of the demagnetization protection barriers may be associated with a first end of each permanent magnet; and a second one of the demagnetization protection barriers may be associated with a second end of each permanent magnet.

The or each demagnetization protection barrier may have a lower magnetic permeability than a surrounding region of the rotor.

The or each demagnetization protection barrier may comprise one or more aperture in the rotor. The one or more aperture may be hollow or may be filled with a material having a low permeability. For example, one or more insert composed of a material having a low magnetic permeability may be inserted into an aperture.

The or each demagnetization protection barrier may extend in a longitudinal direction substantially parallel to a rotational axis of the rotor. The or each demagnetization protection barrier may extend through the rotor.

The demagnetization event may comprise a short circuit event of the electric machine.

According to a further aspect of the present invention there is provided a rotor for an electric machine, the rotor comprising:
a plurality of magnet mounting apertures;
a plurality of circumferential rotor sections, each circumferential rotor section being formed between one or more of the magnet mounting apertures and an outer circumference of the rotor;
wherein each circumferential rotor section comprises at least one demagnetization protection barrier. The or each demagnetization protection barrier is configured to control a magnetic field applied to a permanent magnet disposed in the magnet mounting aperture during a demagnetization event. The at least one demagnetisation protection barrier in each circumferential rotor section may control or modify the flux density distribution locally. For example, the demagnetisation protection barrier(s) may modify the flux distribution across the one or more magnet mounting apertures. The rotor is suitable for use in the rotor assembly described herein. The rotor may comprise one or more of the features described herein with reference to the rotor for the rotor assembly. One or more permanent magnet may be disposed in each magnet mounting aperture formed in the rotor.

According to a further aspect of the present invention there is provided an electric machine comprising a rotor as described herein.

According to a further aspect of the present invention there is provided an electric machine comprising a rotor assembly as described herein.

According to a further aspect of the present invention there is provided an electric drive unit comprising a rotor assembly as described herein.

According to a further aspect of the present invention there is provided a vehicle comprising at least one electric machine as described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle incorporating an electric machine in accordance with an embodiment of the present invention;

FIG. 2 shows a longitudinal sectional view of the electric machine shown in FIG. 1;

FIG. 3 shows a transverse sectional view of the electric machine shown in FIG. 1;

FIG. 4 shows an enlarged view of a circumferential section of the rotor comprising demagnetization protection barriers in accordance with an aspect of the present invention;

FIG. 5A illustrates the flux lines in the electric machine during normal operation;

FIG. 5B illustrates the flux lines in the electric machine during a demagnetization event;

FIG. 6A illustrates the flux lines in a rotor pole of the electric machine during normal operation;

FIG. 6B illustrates the flux lines in a rotor pole of the electric machine during a demagnetization event;

FIG. 7A illustrates the flux lines in a permanent magnet during normal operation;

FIG. 7B illustrates the flux lines in a permanent magnet during a demagnetization event;

FIG. 8A illustrates the magnitude of the magnetic field during a demagnetization event in a rotor having demagnetization protection barriers;

FIG. 8B illustrates the magnitude of the magnetic field during a demagnetization event in a rotor which does not have demagnetization protection barriers;

FIG. 9A illustrates the flux lines in the permanent magnet shown in FIG. 8A during a demagnetization event;

FIG. 9B illustrates the flux lines in the permanent magnet shown in FIG. 8B during a demagnetization event;

FIG. 10A illustrates the flux lines in the permanent magnet during a demagnetization event in a rotor having demagnetization protection barriers;

FIG. 10B illustrates the flux lines in the permanent magnet during a demagnetization event in a rotor which does not have demagnetization protection barriers;

FIG. 11A shows an enlarged view of a corner of the permanent magnet shown in FIG. 10A; and FIG. 11B shows an enlarged view of a corner of the permanent magnet shown in FIG. 10B.

### DETAILED DESCRIPTION

An electric machine 1 in accordance with an embodiment of the present invention is described herein with reference to the accompanying Figures.

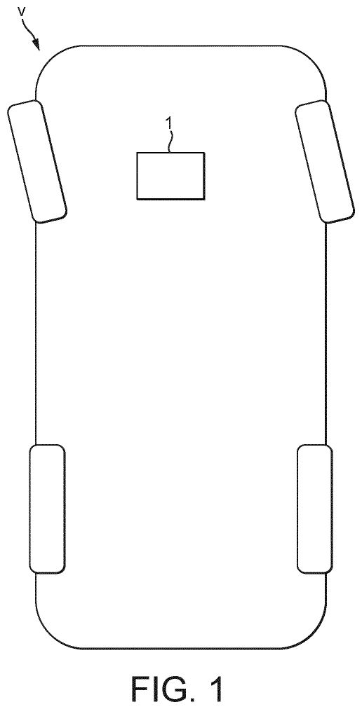

As illustrated in FIG. 1, the electric machine 1 has particular application as an electric drive unit (EDU) in a vehicle V, such as an automobile, a utility vehicle or a tractor unit. In use, the EDU generates a force to propel the vehicle V. The EDU may be used independently, for example in a battery electric vehicle (BEV) application; or in conjunction with an internal combustion engine (not shown), for example in a hybrid electric vehicle (HEV) application or a plug-in hybrid electric vehicle (PHEV) application. However, it will be understood that the electric machine 1 may be used in other applications.

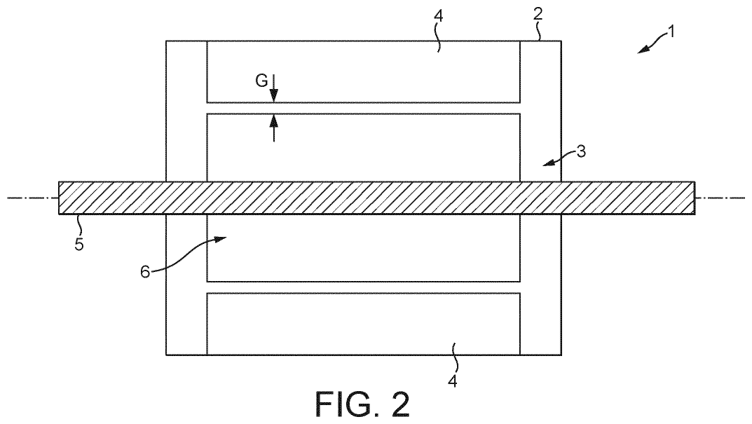

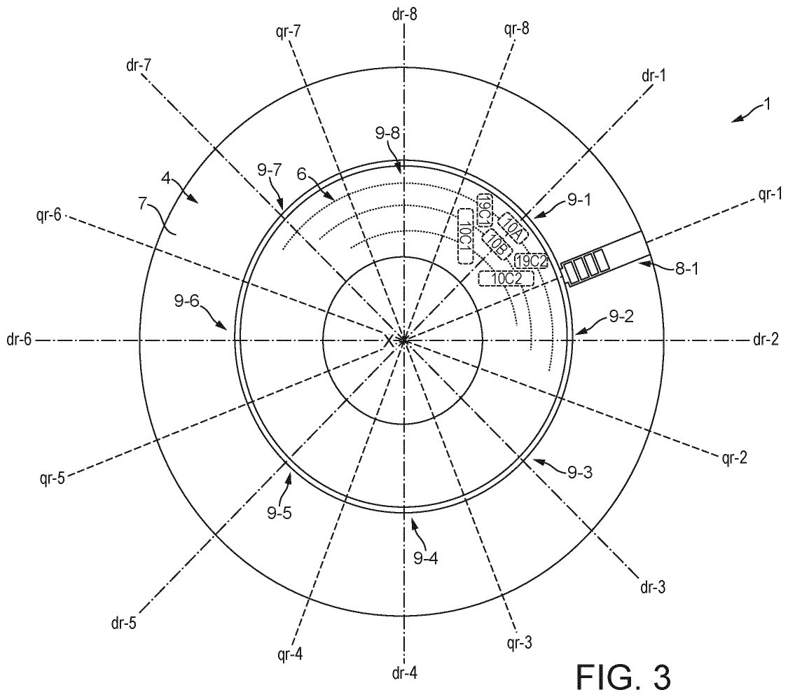

As shown in FIG. 2, the electric machine 1 comprises a housing 2, a rotor assembly 3, a stator 4 and a drive shaft 5. The electric machine 1 is described herein with reference to a longitudinal axis X about which the rotor assembly 3 and the drive shaft 5 rotates. The rotor assembly 3 comprises a rotor (core) 6 which is mounted to the drive shaft 5 (shown in FIG. 3). The rotor 6 is fixedly mounted to the drive shaft 5 such that the rotor 6 and the drive shaft 5 rotate together. The rotor 6 has an outer circumference C1 which is spaced apart from the stator 4 to form an air gap G. The rotor 6 is made up of a plurality of laminations of a ferromagnetic material to form a rotor iron (or rotor core). As shown in FIG. 3, the stator 4 comprises a cylindrical stator core 7. The stator core 7 is composed of a plurality of laminations of a ferromagnetic material. The stator core 7 comprises a plurality of slots 8-n extending radially inwardly.

The electric machine 1 in the present embodiment is a permanent magnet synchronous motor. As shown in FIG. 3, the rotor 6 comprises eight (8) rotor poles 9-n. The rotor poles 9-n each extend radially outwardly from the longitudinal axis X. The rotor poles 9-n each have a direct axis dr-n and a quadrature axis qr-n. The rotor poles 9-n have an equal angular spacing (i.e. a pitch of 45° between the direct axes dr-n of adjacent rotor poles 9-n). The rotor poles 9-n each comprise at least one permanent magnet 10 mounted in the rotor 6. The rotor poles 9-n in the present embodiment each comprise first and second permanent magnets 10A, 10B (represented in FIG. 3 by dashed lines) which are spaced apart from each other in a radial direction. The rotor poles 9-n each comprise a pair of third permanent magnets 10C1, 10C2. The third permanent magnets 10C1, 10C2 are arranged in a V-shaped configuration. It will be understood that the rotor 6 can comprise less than or more than eight (8) rotor poles 9-n. The rotor 6 may comprise different numbers of pole numbers 9-n, for example the rotor 6 may comprise 2, 4, 6 or rotor poles. The rotor poles 9-n may have different numbers of permanent magnets 10A, 10B, 10C. Furthermore, the configuration of the permanent magnets 10A, 10B, 10C may be changed in each rotor pole 9-n.

The first, second and third permanent magnets 10A, 10B, 10C are located in respective first, second and third magnet receiving apertures formed in the rotor 6. (Only the first magnet receiving aperture 11A is illustrated in the Figures for clarity.) The first permanent magnet 10A has a first longitudinal axis; and the second permanent magnet 10B has a second longitudinal axis. As shown in FIG. 3, the first and second permanent magnets 10A, 10B extend substantially perpendicular to the direct axis dr-n of each rotor pole 9-n. Accordingly, the first and second longitudinal axes extend in a substantially tangential direction.

The first permanent magnet 10A has opposing first ends 15A, 15B disposed on respective sides of the direct axis dr-n. The second permanent magnet 10B has opposing ends 16A, 16B disposed on respective sides of the direct axis dr-n. The third permanent magnets 10C1, 10C2 each have a longitudinal axis inclined at an acute angle to the direct axis dr-n of the rotor pole 9-n. The third permanent magnets 10C1, 10C2 are thereby arranged in a first V-shaped configuration. Other configurations of the permanent magnets in the rotor 6 are contemplated. For example, the rotor 6 may comprise a single set of permanent magnets arranged in a V-shaped configuration.

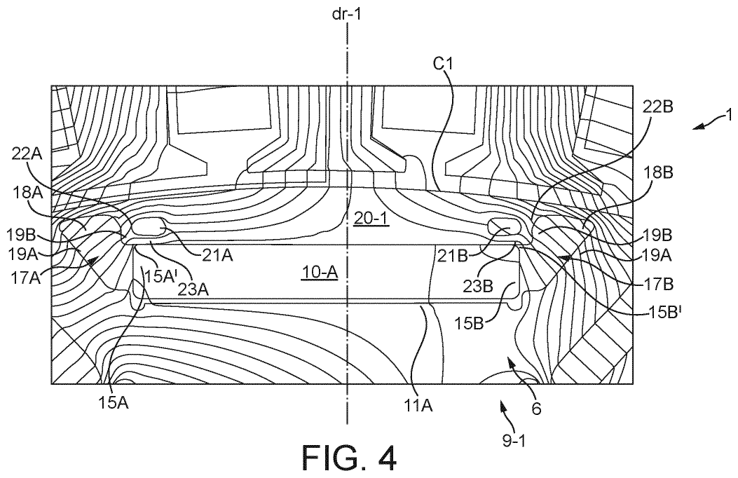

The rotor poles 9-n have substantially the same configuration. For brevity, the first rotor pole 9-1 will now be described. An enlarged view of an outer portion of the first rotor pole 9-1 is shown in FIG. 4. The first magnet receiving apertures 11A are configured to form a first flux barrier 17A, 17B at each end 15A, 15B of the first permanent magnet 10A to control magnetic flux in the rotor 6. In the present embodiment the first flux barriers 17A, 17B each comprise a hollow aperture formed by extending each side of the first magnet receiving apertures 11A. The first flux barriers 17A, 17B each comprise an extension portion 18A, 18B which extends outwardly towards the outer circumference C1 of the rotor 6. The extension portions 18A, 18B each have an outer flux barrier edge 19A and an inner flux barrier edge 19B. The outer flux barrier edge 19A forms the outer lateral edge of the extension portions 18A, 18B; and the inner flux barrier edge 19B forms the inside lateral edge of the extension portions 18A, 18B. In the present embodiment the outer flux barrier edge 19A extends at an acute angle to the direct axis dr-1; and the inner flux barrier edge 19B extends substantially parallel to the direct axis dr-1. Part of the inner flux barrier edge 19B extends substantially perpendicular to the longitudinal axis of the first permanent magnet 10A disposed in the first rotor pole 9-1. The ends 15A, 15B of the first permanent magnet 10A are inset from the respective inner flux barrier edges 19B. First and second flux barriers 19C1, 19C2 are disposed on opposing sides of the second permanent magnet 10B.

The first and second flux barriers 19C1, 19C2 are inclined at an acute angle relative to a radius of the rotor 6 in a V-shaped configuration.

The first rotor pole 9-1 comprises a circumferential rotor section 20-1. The circumferential rotor section 20-1 is formed in the rotor 6 between the first magnet receiving aperture 11A and the outer circumference C1. The circumferential rotor section 20-1 constitutes a sector of the rotor 6. At least one demagnetization protection barrier 21 is formed in the circumferential rotor section 20-1. The at least one demagnetization protection barrier 21 is configured to control the magnetic field applied to the first permanent magnet 10A during a demagnetization event. The at least one demagnetization protection barrier 21 is configured to reduce the magnetic flux applied to the end of the first permanent magnet 10A, particularly the magnetic flux applied at or proximal to an outer corner 15A′, 15B′ of the first permanent magnet 10A (shown in FIG. 4). The or each demagnetization protection barrier 21 is suitable for controlling the magnetic field in the rotor 6 to reduce a magnetic flux applied to the corners 15A′ and 15B′ of the first permanent magnet 10A during a demagnetization event. The at least one demagnetization protection barrier 21 each comprise an aperture formed in the rotor 6. The at least one demagnetization protection barrier 21 is distinct from the first magnet receiving aperture 11A and the first flux barriers 17A, 17B. In the illustrated arrangement each demagnetization protection barrier 21 is hollow. It will be understood that the demagnetization protection barrier(s) 21 could be filed, for example with a material having a low magnetic permeability (compared to the rotor 6).

In the present embodiment, first and second demagnetization protection barriers 21A, 21B are formed in the circumferential rotor section 20-1. The first and second demagnetization protection barriers 21A, 21B are associated with respective ends 15A, 15B of the first permanent magnet 10A. As shown in FIG. 4, the first and second demagnetization protection barriers 21A, 21B are inset from the extension portions 18A, 18B of the first flux barriers 17A, 17B. The first and second demagnetization protection barriers 21A, 21B are formed inboard of the inner flux barrier edges 19B of the respective extension portions 18A, 18B of the first flux barriers 17A, 17B. The first and second demagnetization protection barriers 21A, 21B are formed proximal to (but spaced apart from) the ends 15A, 15B of the first permanent magnet 10A. During a demagnetization event, the first and second demagnetization protection barriers 21A, 21B are operative to direct a portion of the magnetic field in the circumferential rotor section 20-1 inwardly through the first permanent magnet 10A inboard of the ends 15A, 15B. The peak magnetic flux through the first permanent magnet 10A may thereby be reduced compared to an arrangement which does not have demagnetization protection barriers. The demagnetization of the first permanent magnet 10A may be reduced.

The first and second demagnetization protection barriers 21A, 21B are symmetrical about the direct axis dr-1 and have like configurations. For brevity, the shape and positioning of the first demagnetization protection barrier 21A will now be described. The first demagnetization protection barrier 21A is separate from the first magnet receiving aperture 11A and the first flux barrier 17A. A first bridge region 22A is formed between the first magnet receiving aperture 11A and the first demagnetization protection barrier 21A. The first bridge region 22A has a substantially constant width along its length. A second bridge region 23A is formed between the first demagnetization protection barrier 21A and the inner flux barrier edge 19B of the extension portion 18A of the first flux barrier 17A. The second bridge region 23A has a substantially constant width along its length. The first and second bridge regions 22A, 23A are contiguous and extend substantially perpendicular to each other. The first demagnetization protection barrier 21A has a central longitudinal axis. The first demagnetization protection barrier 21A is formed such that the central longitudinal axis is at least substantially aligned with a local direction of the magnetic field in the rotor 6 during a demagnetization event. The radial extent of the first demagnetization protection barrier 21A increases towards the direct axis dr-1 of the first rotor pole 9-1.

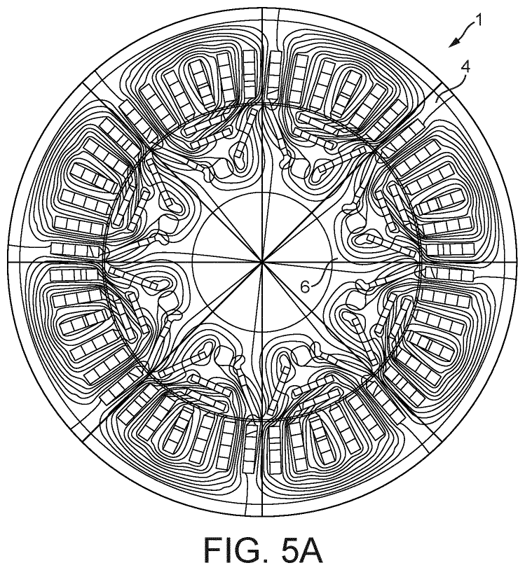

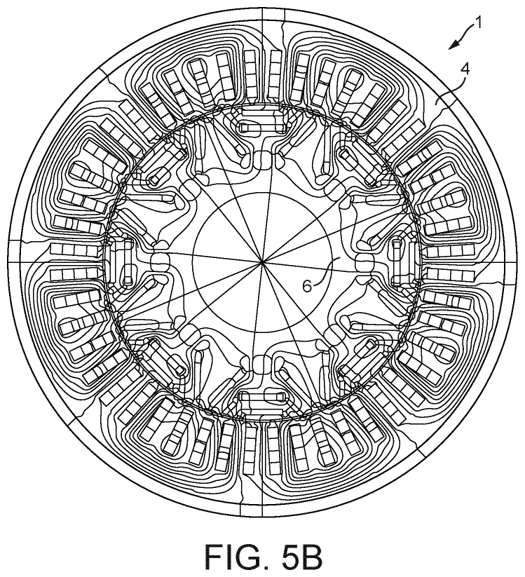

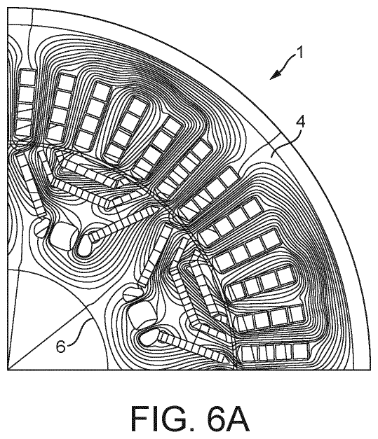

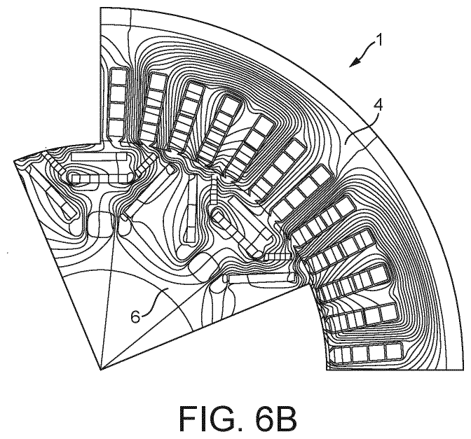

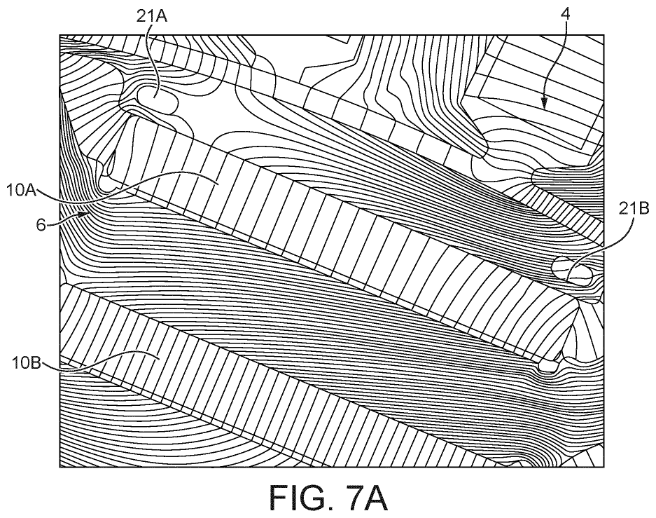

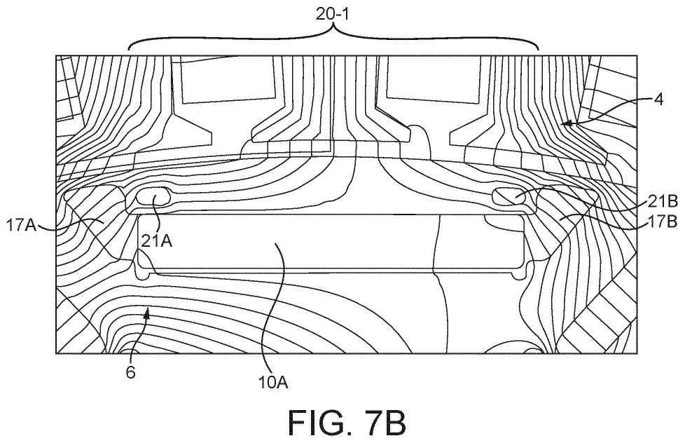

The function of the first and second demagnetization protection barriers 21A, 21B during a demagnetization event will now be described with reference to FIGS. 5 to 10. The demagnetization event comprises a transient short circuit test as this results in high demagnetization levels. The function of the first and second demagnetization protection barriers 21A, 21B is described with particular reference to the first permanent magnet 10A disposed closest to the air gap G between the stator 4 and the rotor 6. The flux lines in the stator 4 and the rotor 6 during normal operation are illustrated in FIGS. 5A, 6A and 7A. The flux lines in the stator 4 and the rotor 6 during a 3-phase transient short circuit are illustrated in FIG. 5B, 6B and 7B. The flux lines in the circumferential rotor section 20-1 during a demagnetization event are shown most clearly in FIG. 7B.

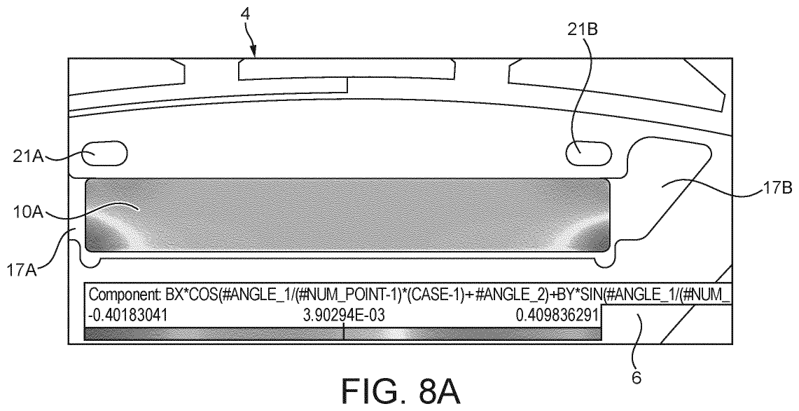

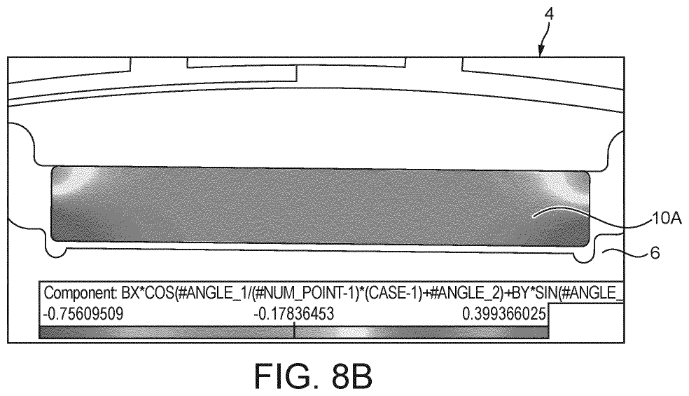

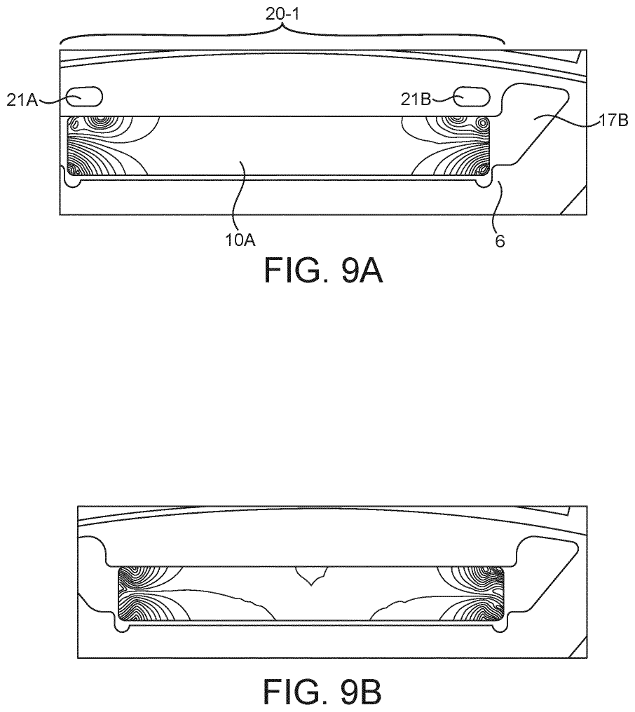

The strength (magnitude) of the magnetic field in the first permanent magnet 10A during a demagnetization event is shown in FIGS. 8A and 8B. The equivalent magnetic flux lines in the first permanent magnet 10A during the demagnetization event are shown in FIGS. 9A and 9B. The rotor 6 shown in FIGS. 8A and 9A comprises the first and second demagnetization protection barriers 21A, 21B in accordance with the present embodiment. The rotor 6 shown in FIGS. 8B and 9B does not include first and second demagnetization protection barriers 21A, 21B. As shown in FIG. 8A, the first and second demagnetization protection barriers 21A, 21B are effective in reducing the peak magnitude of the magnetic field in the first permanent magnet 10A during the demagnetization event. The first and second demagnetization protection barriers 21A, 21B are effective in reducing the local maximums of the magnetic field. It is believed that this may be achieved, at least in part, by the increased distribution of the magnetic field throughout the first permanent magnet 10A during the demagnetization event. As shown in FIG. 9A, the magnetic flux lines in the outer region of the first permanent magnet 10A closest to the air gap G are distributed towards a central region of the first permanent magnet 10A (i.e. towards the direct axis dr-1), thereby reducing the magnetic flux incident at the outer corners 15A′, 15B′ of the first permanent magnet 10A. The flux density is more evenly distributed in the arrangement in which the rotor 6 comprises the first and second demagnetization protection barriers 21A, 21B compared to the alternative arrangement in which the rotor 6 does not have first and second demagnetization protection barriers 21A, 21B.

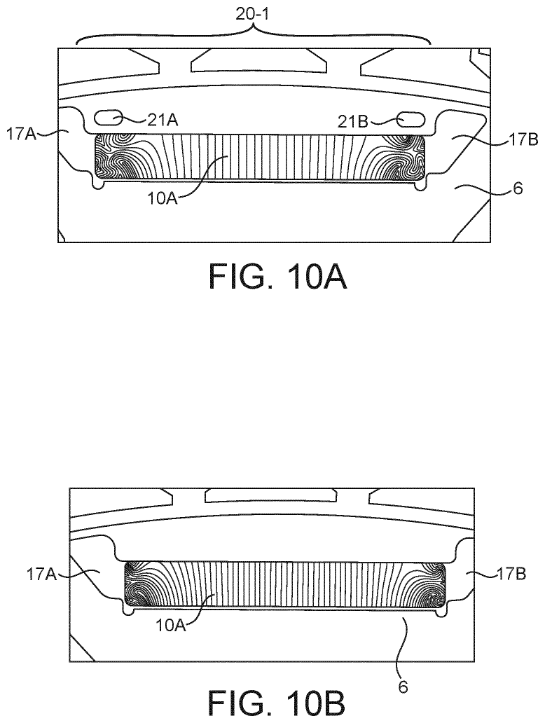

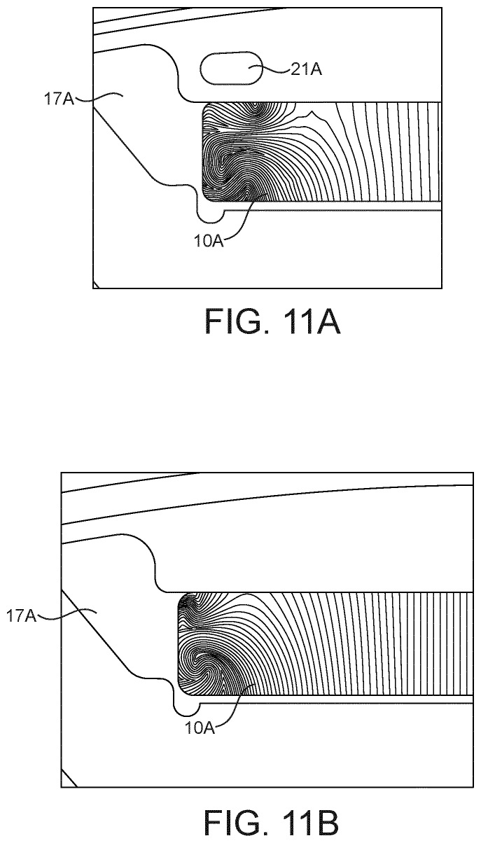

A further illustration of the magnetic flux lines in the first permanent magnet 10A during the demagnetization event are shown in FIGS. 10A, 10B, 11A and 11B. The rotor 6 shown in FIGS. 10A and 11A comprises the first and second demagnetization protection barriers 21A, 21B in accordance with the present embodiment. The rotor 6 shown in FIGS. 1013 and 11B does not include first and second demagnetization protection barriers 21A, 21B. As can be observed in FIGS. 10A and 11A, the first and second demagnetization protection barriers 21A, 21B result in a wider distribution of flux lines in the first permanent magnet 10A, particularly proximal to the outer corners 15A′, 15B′ of the first permanent magnet 10A closest to the air gap G. By way of comparison, the flux lines are more concentrated at the corners of the first permanent magnet 10A in the arrangement in which the rotor 6 which does not have first and second demagnetization protection barriers 21A, 21B, as shown in FIGS. 10B and 11B. During a demagnetization event, the first and second demagnetization protection barriers 21A, 21B are operative to increase the distribution of the flux lines throughout the first permanent magnet 10A, thereby reducing the magnitude of the magnetic field incident at the corners of the permanent magnet 10A.

The direction of the magnetic flux during a demagnetization event may be approximately perpendicular to a direction of the magnetic flux during normal operation. The demagnetization protection barriers 21A, 21B have a higher reluctance in a first direction than in a second direction which is perpendicular. For example, the demagnetization protection barriers 21A, 21B may be elongated in the first direction. The first direction may be at least substantially aligned with the magnetic flux in the rotor 6 during a demagnetization event. The second direction may be at least substantially aligned with the magnetic flux in the rotor 6 during normal operation. Thus, the at least one demagnetization protection barrier 21A, 21B causes greater reluctance during a demagnetization event than during normal operation.

It will be appreciated that various changes and modifications can be made to the present invention without departing from the scope of the present application.

1. A rotor assembly for an electric machine, the rotor assembly comprising:
a rotor;
a plurality of permanent magnets mounted in respective magnet mounting apertures formed in the rotor, each permanent magnet having first and second ends;
a plurality of circumferential rotor sections, each circumferential rotor section being formed between one or more of the magnet mounting apertures and an outer circumference of the rotor;
wherein each circumferential rotor section comprises at least one demagnetization protection barrier for controlling a magnetic field applied to an associated one of the permanent magnets during a demagnetization event.

2. A rotor assembly as claimed in claim 1, wherein the at least one demagnetization protection barrier is suitable for controlling a direction of the magnetic field in the circumferential rotor section during the demagnetization event to reduce the magnetic flux at a first corner disposed at the first end of the associated permanent magnet and/or to reduce the magnetic flux at a second corner disposed at the second end of the associated permanent magnet.

3. A rotor assembly as claimed in claim 1, wherein the at least one demagnetization protection barrier is suitable for directing a portion of the magnetic field in the circumferential rotor section inwardly through the associated permanent magnet inboard of the first end or the second end.

4. A rotor assembly as claimed in claim 1, wherein the or each demagnetization protection barrier in each circumferential rotor section is disposed in a position inset from the first end or the second end of the associated permanent magnet.

5. A rotor assembly as claimed in claim 1, wherein each magnet mounting aperture comprises first and second extension portions associated with respective first and second ends of the permanent magnet; the or each demagnetization protection barrier in each circumferential rotor section being disposed inboard of the first and second extension portions.

6. A rotor assembly as claimed in claim 1, wherein each circumferential rotor section comprises first and second recesses formed in the outer circumference of the rotor, the or each demagnetization protection barrier in each circumferential rotor section being disposed in a position outboard of one of the first and second recesses.

7. A rotor assembly as claimed in claim 1, wherein the or each demagnetization protection barrier is elongated along one of:
a longitudinal axis at least substantially aligned with a local direction of the magnetic field during the demagnetization event; or
a longitudinal axis at least substantially perpendicular to a radius of the rotor extending through a centre of the associated permanent magnet.

8. A rotor assembly as claimed in claim 1, wherein the or each demagnetization protection barrier in each circumferential rotor section is positioned at least substantially midway between the magnet mounting aperture and the outer circumference of the rotor.

9. A rotor assembly as claimed in claim 1, wherein, within each circumferential rotor section, a first one of the demagnetization protection barriers is associated with the first end of each permanent magnet; and a second one of the demagnetization protection barriers is associated with the second end of each permanent magnet.

10. A rotor assembly as claimed in claim 1, wherein the or each demagnetization protection barrier has a lower magnetic permeability than a surrounding region of the rotor.

11. A rotor assembly as claimed in claim 1, wherein the or each demagnetization protection barrier comprises an aperture in the rotor.

12. A rotor for an electric machine, the rotor comprising:
a plurality of magnet mounting apertures;
a plurality of circumferential rotor sections, each circumferential rotor section being formed between one or more of the magnet mounting apertures and an outer circumference of the rotor;
wherein each circumferential rotor section comprises at least one demagnetization protection barrier.

13. An electric machine comprising a rotor assembly as claimed in claim 1.

14. An electric drive unit comprising an electric machine as claimed in claim 13.

15. A vehicle comprising at least one electric machine as claimed in claim 13.

16. A rotor assembly as claimed in claim 4, wherein a radial extent of the or each demagnetization protection barrier increases in a circumferential direction towards a centre of the associated permanent magnet.
